(19) United States
(12) Patent Application Publication
(10) Pub. No.: US 2025/0258582 A1
(43) Pub. Date: Aug. 14, 2025

(54) DISPLAY DEVICE FOR DEEP LINK AND CONTROL METHOD THEREFOR

(71) Applicant: SAMSUNG ELECTRONICS CO., LTD., Suwon-si (KR)

(72) Inventor: Dasom KIM, Suwon-si (KR)

(73) Assignee: SAMSUNG ELECTRONICS CO., LTD., Suwon-si (KR)

(21) Appl. No.: 19/193,304

(22) Filed: Apr. 29, 2025

Related U.S. Application Data
(63) Continuation of application No. PCT/KR2023/014169, filed on Sep. 19, 2023.

(30) Foreign Application Priority Data
Nov. 9, 2022 (KR) 10-2022-0148657

(51) Int. Cl. G06F 3/0482

(52) U.S. Cl. CPC G06F 3/0482

(57) ABSTRACT

A display device for a deep link and controlling method thereof including: displaying deep link windows and an application list in association with application execution buttons and deep link buttons respectively corresponding to content data and detecting a focus input. Based on the focus input, changing an arrangement configuration of the deep link windows, at least partially, based on an attribute of an application of interest corresponding to an execution button in association with which the focus input has been detected and a location of a deep link window associated with the application of interest; based on receiving a selection input with respect to any one of the deep link buttons, obtaining content data corresponding to a deep link button in association with which the selection input and executing the obtained content data by using an application associated with the deep link button.

### CROSS-REFERENCE TO RELATED APPLICATIONS

This application is a continuation application of International Application No. PCT/KR2023/014169, filed on Sep. 19, 2023, in the Korean Intellectual Property Receiving Office, which claims priority from Korean Patent Application No. 10-2022-0148657, filed on Nov. 9, 2022, in the Korean Intellectual Property Office, the disclosures of which are hereby incorporated by reference herein in their entireties.

### BACKGROUND

### Field

The disclosure relates to a display device for a deep link and a method for controlling the same.

### Description of Related Art

Content providers may provide various multimedia content to users through a content system. Multimedia content may be transmitted from any source, including a content provider's computing system, to a user's display system. The display system may provide multimedia content using an application associated with the multimedia content. Meanwhile, the user should perform multiple interactions to execute multimedia content using the display system. For example, the user should execute a necessary application and, after executing the application, search desired multimedia content. To minimize the interaction process, the display system implements a manipulation for calling a bar-type window for guiding to applications associated with content, thereby providing an enhanced user experience.

### SUMMARY

The disclosure provides a display device capable of displaying content data executable through a deep link for each application through one interface and a method for controlling the same.

According to an aspect, a method for controlling a display device for a deep link is provided. In an embodiment, a method may comprise displaying deep link windows and an application list in association with application execution buttons and deep link buttons respectively corresponding to content data, detecting a focus input with respect to any one of the application execution buttons, based on the focus input being detected for a predefined enable time or more, changing an array setting of the deep link windows, at least partially, based on an attribute of an application of interest corresponding to an execution button in association with which the focus input is detected and a position of a deep link window associated with the application of interest, based on receiving a selection input with respect to any one of the deep link buttons, obtaining content data corresponding to the deep link button in association with which the selection input is received, and executing the obtained content data in an application associated with the deep link button.

In an embodiment, the attribute may include a content providing attribute and a content non-providing attribute. An application having the content providing attribute or the application of interest may be capable of executing the content data, and an application having the content non-providing attribute may be incapable of executing the content data.

In an embodiment, the deep link windows may respectively correspond to applications having the content providing attribute.

In an embodiment, applications having the content non-providing attribute may have no deep link window respectively corresponding thereto.

In an embodiment, the deep link buttons may include preview images associated with the content data respectively corresponding thereto.

In an embodiment, the deep link windows may form an array of a first row to an Mth row (where M is a natural number of 2 or more), and based on the application of interest having a content providing attribute, and the position of the deep link window associated with the application of interest corresponding to the Mth row, the array setting may be unchanged.

In an embodiment, the deep link windows may form an array of a first row to an Mth row (where M is a natural number of 2 or more), and based on the application of interest having a content providing attribute, and the position of the deep link window associated with the application of interest corresponding to the Mth row (where M is a natural number of 2 or more), the array setting may be changed so that deep link windows of the first row to an M−1th row are positioned in a second row to the Mth row, and the deep link window associated with the application of interest is positioned in the first row.

In an embodiment, based on the application of interest having a content non-providing attribute, the array setting may unchanged.

In an embodiment, the method may comprise changing the array setting to a default setting which is a setting before the focus input is detected based on the detection of the focus input being stopped.

According to an aspect, a method for controlling a display device for a deep link is provided. According to an embodiment, a method may comprise displaying an interface including an application list including application execution buttons and deep link windows, the deep link windows including deep link buttons respectively corresponding to content data, and forming an array of a first row to an Mth row (where M may be a natural number of 2 or more), detecting a focus input with respect to any one of the execution buttons, based on the focus input detected for a predefined enable time or more, identifying an attribute of an application of interest corresponding to an execution button in association with which the focus input is detected, generating a deep link window associated with the application of interest based on the attribute of the application of interest, changing an array setting of the deep link windows by moving deep link windows of the first row to the Mth row to a second row to an M+1th row and positioning the generated deep link window associated with the application of interest in the first row, based on receiving a selection input with respect to any one of the deep link buttons, obtaining content data corresponding to the deep link button where the selection input may be received, and executing the obtained content data in an application associated with the deep link button.

In an embodiment, based on the deep link window associated with the application of interest being generated, a deep link window moved to the M+1th row may be omitted from the interface.

In an embodiment, based on the deep link window associated with the application of interest being generated, a number of deep link windows included in the interface may be increased to M+1.

In an embodiment, the method may comprise, based on the detection of the focus input being stopped, omitting the generated deep link window associated with the application of interest from the interface and changing the array setting to a default setting which is a setting before the focus input is detected.

According to an aspect, a display device for a deep link is proposed. A display device may comprise one or more processors, memory, and one or more programs stored in the memory and configured to be executed by the one or more processors. The one or more programs may include instruction for performing displaying deep link windows and an application list including application execution buttons and deep link buttons respectively corresponding to content data, detecting a focus input with respect to any one of the application execution buttons, based on the focus input being detected for a predefined enable time or more, changing an array setting of the deep link windows, at least partially, based on an attribute of an application of interest corresponding to an execution button in association with which the focus input is detected and a position of an deep link window associated with the application of interest, based on receiving a selection input with respect to any one of the deep link buttons, obtaining content data corresponding to the deep link button in association with which the selection input is received, and executing the obtained content data in an application associated with the deep link button.

In an embodiment, the attribute may include a content providing attribute and a content non-providing attribute. An application having the content providing attribute or the application of interest may be capable of executing the content data, and an application having the content non-providing attribute may be incapable of executing the content data.

In an embodiment, the deep link windows may form an array of a first row to an Mth row (where M is a natural number of 2 or more), and based on the application of interest having a content providing attribute, and the position of the deep link window associated with the application of interest corresponding to the Mth row, the array setting may not be changed.

In an embodiment, the deep link windows may form an array of a first row to an Mth row (where M is a natural number of 2 or more), and based on the application of interest having a content providing attribute, and the position of the deep link window associated with the application of interest corresponding to the Mth row, the array setting may be changed so that deep link windows of the first row to an M−1th row are positioned in a second row to the Mth row, and the deep link window associated with the application of interest is positioned in the first row.

In an embodiment, based on the application of interest having a content non-providing attribute, the array setting may not be changed.

In an embodiment, the program may include an instruction for performing changing the array setting to a default setting which is a setting before the focus input is detected based on the detection of the focus input being stopped.

According to various embodiments of the disclosure, it is possible to simultaneously represent content data executable through a deep link for each application even without the hassle of identifying them by representing contents executable through a deep link for each of various applications through a home interface.

Effects achievable in example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF THE DRAWINGS

FIGS. 1A, 1B to 1C are exemplary block diagrams illustrating a network environment for a deep link according to an embodiment of the present disclosure;

FIG. 2 is an exemplary flowchart illustrating a method for controlling a display system for a deep link according to an embodiment of the present disclosure;

FIG. 3 is a reference view illustrating a home interface according to an embodiment of the present disclosure;

FIG. 4 is a reference view illustrating a deep link window according to an embodiment of the present disclosure;

FIGS. 5 and 6 are reference views illustrating a process of moving an interested deep link window according to an embodiment of the present disclosure;

FIG. 7 is a reference view illustrating a process of generating and then moving an interested deep link window according to an embodiment of the present disclosure; and

FIG. 8 illustrates an exemplary computer system according to an embodiment of the present disclosure.

Reference may be made to the accompanying drawings in the following description, and specific examples that may be practiced are shown as examples within the drawings. Other examples may be utilized and structural changes may be made without departing from the scope of the various examples.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

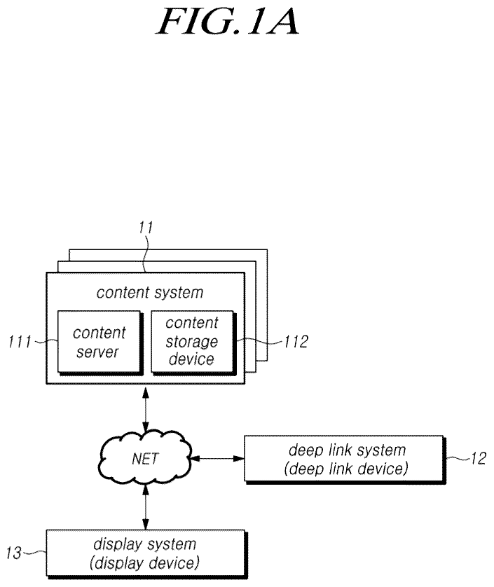

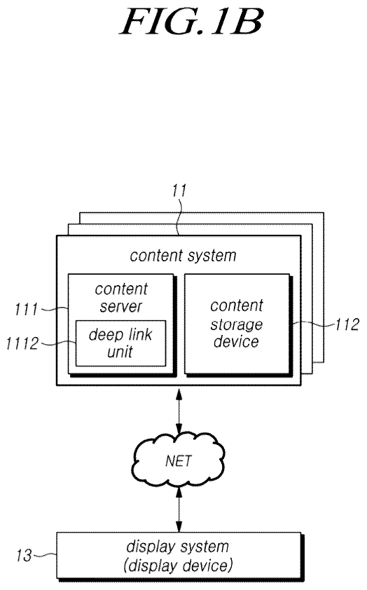

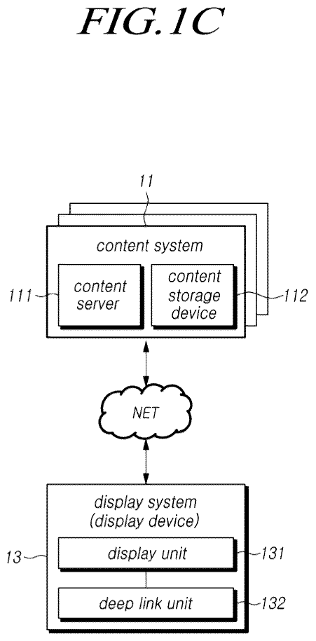

FIGS. 1A, 1B to 1C are exemplary block diagrams illustrating a network environment for a deep link.

Referring to FIG. 1A, a network environment for a deep link may include one, or two or more content systems 11, a deep link system 12, and one, or two or more display system 13. The deep link system 12 may be referred to as a deep link device. The display system 13 may be referred to as a display device.

In an embodiment, the content system 11 may provide content data to an external device. The content system 11 may be connected to the deep link system 12 and/or the display system 13 through a network. The content system 11 may provide content data to the display system 13.

In an embodiment, the content system 11 may include a content server 111.

The content server 111 may provide various content data to an external device. For example, the content server 111 may provide various content data to the display system 13. Further, the content server 111 may transmit and receive information, data, or commands to and from the display system 13 and/or the deep link system 12 according to predefined rules. For example, based on receiving a content providing request including a uniform resource identifier (URI) from the display system 13, the content server 111 may provide content data corresponding to the URI to the display system 13.

The content server 111 may manage content data or various programs recorded in the content storage device 112. Various content data to be provided to an external device or an external system may be recorded in the content storage device 112. For example, content data of various multimedia such as movies, dramas, and music may be recorded in the content storage device 112. The content server 111 may read various data recorded in the content storage device 112 and provide it to an external device or an external system. Further, the content server 111 may delete the content data recorded in the content storage device 112 or add new content data to the content storage device 112.

In an embodiment, the content system 11 or the content server 111 may correspond to an application executable in the display system 13. In an embodiment, a first content system may correspond to a first application, and a second content system may correspond to a second application. Accordingly, the user may receive and execute content data stored in the content storage device of the first content system by executing the first application. Further, the user may receive and execute content data stored in the content storage device of the second content system by executing the second application.

Meanwhile, various applications capable of executing multimedia content may be stored in the memory of the display system 13. The applications capable of executing multimedia content may include, e.g., over-the-top media service (OTT) applications, video playback applications, and sound source playback applications, but are not limited thereto.

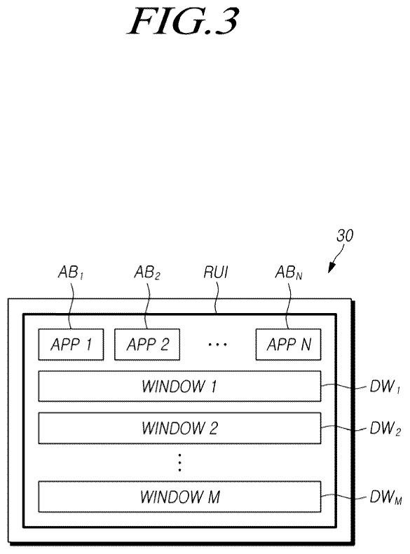

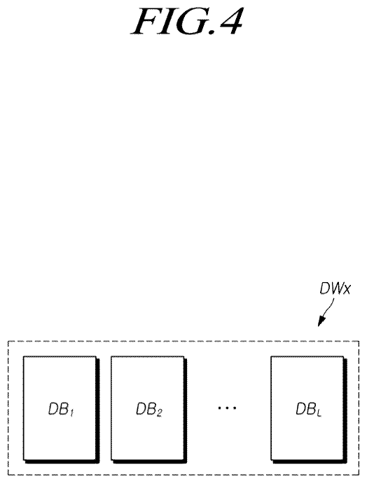

In an embodiment, the deep link system 12 may generate/manage/update a home interface for a deep link, or generate/manage/update home interface information for the same. The deep link system 12 may include a deep link device. Although not limited thereto, the deep link device may be provided in the form of a server. The home interface may include various user interface elements to be described below with reference to FIGS. 3 and 4. The home interface information may be information that is a basis for configuring the home interface. In an embodiment, the display system 13 may generate a home interface based on home interface information. Meanwhile, the home interface information may include an array setting for arranging the user interface elements. In an embodiment, at least a portion of the home interface information may configure window setting information to be described below, but is not limited thereto.

In an embodiment, the deep link system 12 may generate a home interface and transmit the home interface to the display system 13. The display system 13 may display the received home interface on the display.

In an embodiment, the deep link system 12 may generate home interface information and transmit it to the display system 13. If the display system 13 receives the home interface information, the display system 13 may generate a home interface based on the home interface information. The display system 13 may display the generated home interface on the display. In an embodiment, the home interface information may include at least one of a thumbnail image and a URI, and the thumbnail image and the URI may be a basis for configuring a deep link button. Further, the home interface information may further include an array setting, which may be a basis for determining the array of deep link button(s).

In an embodiment, the home interface generated by the deep link system 12 may include the above-described deep link button(s). The deep link button(s) may be generated or provided differently for each content system. For example, even in the case of the same multimedia content, a first deep link button may be provided for the first content system and a second deep link button may be provided for the second content system. In other words, even for the same multimedia content, a deep link button having a different URI and/or thumbnail image for each content system may be generated.

Further, in an embodiment, the deep link button(s) may be arranged differently for each content system. For example, even for the same multimedia content, based on the array setting, the deep link button(s) may be arranged in a lower order in the first content system and be arranged in a higher order in the second content system. Referring to FIG. 4, the deep link button(s) (e.g., DB₁, DB₂, . . . , DB_{L}) may be positioned on the left side of the row as they have a higher order, and be positioned on the right side of the row as they have a lower order. The home interface or home interface information generated by the deep link system 12 may be provided in response to a request from the display system 13. For example, in response to a request for the home interface from the display system 13, the deep link system 12 may provide the home interface to the display system 13. For example, in response to a request for home interface information from the display system 13, the deep link system 12 may provide home interface information from the display system 13.

In an embodiment, the home interface may include various user interface elements. For example, the user interface element may include application button(s) and deep link button(s). The application button(s) may be arranged on the application list. The deep link button(s) may be arranged on the deep link window. The application button and the deep link button are described below with reference to FIGS. 3 and 4.

Meanwhile, in an embodiment, at least one of the arrangement order and/or arrangement positions of the application button(s), the deep link button(s), and the deep link window(s) may be predefined. In other words, according to a predefined array setting, the arrangement order and/or arrangement positions of the application button(s), the deep link button(s), and the deep link window(s) may be determined. The arrangement order and/or arrangement positions of the application button(s), the deep link button(s), and the deep link window(s) may be customized based on a user input to the display system 13 that substantially displays the home interface.

In an embodiment, the display system 13 may output content data provided from the content system 11. The content data may be formed of at least one of, e.g., image data or voice data, or may include the same. The display system 13 may display content data through a display means such as a display. Further, the display system 13 may output content data as a sound, through a sound output means such as a speaker.

In an embodiment, the display system 13 may output the home interface. For example, the display system 13 may display the home interface provided from the deep link system 12 on the display. For example, the display system 13 may generate the home interface based on home interface information provided from the deep link system 12, and display the generated home interface on the display.

The display system 13 may receive user inputs to various user interface elements represented in the home interface while displaying the home interface. The user input, although not limited thereto, may include a selection input and a focus input. Further, the user input may include up, down, left, and right movement inputs for moving the focus between user interface elements.

Meanwhile, the deep link system 12 may be configured of one electronic component or an electronic circuit for performing substantially the same function. As described above, a component that plays substantially the same role as the deep link system 12 may be referred to as a deep link unit or a deep link device.

In an embodiment, the deep link unit may be included as at least a portion of the content server 111, or may be configured as at least a portion of the processing circuit unit of the display system 13. A deep link unit configured as a portion of the content server 111 is described with reference to FIG. 1B, and a deep link unit configured as a portion of the display system 13 is described with reference to FIG. 1C.

Referring to FIGS. 1B and 1C, a network environment for a deep link may include a content system 11 and a display system 13. The display system 13 may be referred to as a display device, but is not limited thereto.

Referring to FIG. 1B, in an embodiment, the content system 11 may include a content server 111 and a content storage device 112. Further, the content server 111 may include a deep link unit 1112. Here, the deep link unit 1112 refers to various means/devices/circuit units for performing functions/role of the deep link system 12. In an embodiment, the deep link unit 1112 may be included as at least a portion of the content server 111. The deep link unit 1112 may be understood as performing substantially the same function as the deep link system 12 of FIG. 1A.

Referring to FIG. 1C, in an embodiment, the display system 13 may include a display unit 131 and a deep link unit 132. Here, the display unit 131 refers to various means/devices/circuit units for displaying information and a display electrically connected thereto, and the above-described deep link unit 132 refers to various means/devices/circuit units for performing the function/role of the deep link system 12. The display unit 131 may be understood as performing substantially the same function as the display system 13 of FIG. 1A, and the deep link unit 132 may be understood as performing substantially the same function as the deep link system 12 of FIG. 1A.

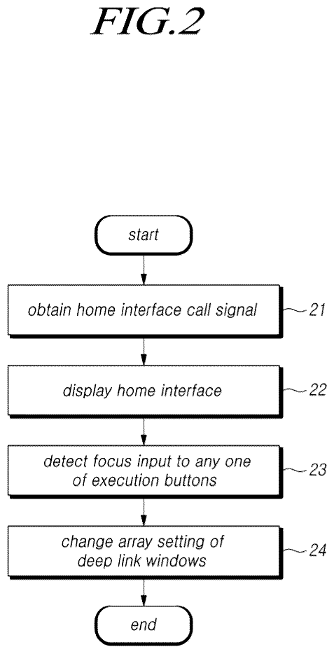

FIG. 2 is an exemplary flowchart illustrating a method for controlling a display system for a deep link.

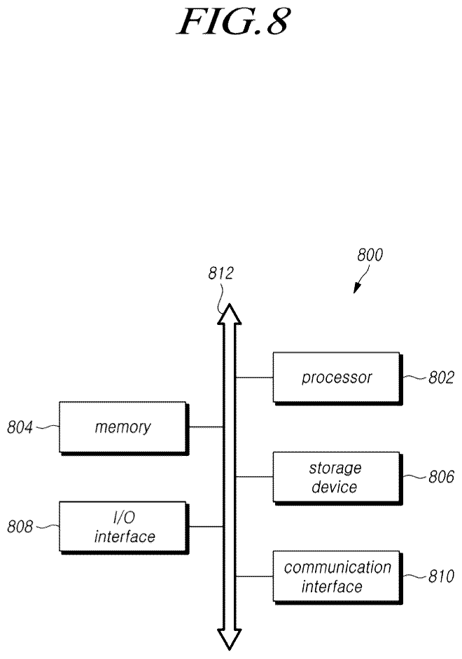

The control method of the disclosure may be performed by the content system, the deep link system, and/or the display system described above with reference to FIGS. 1A to 1C. Here, the content system, the deep link system, and/or the display system are examples of the computer system to be described in FIG. 8 and may include a processor, memory, a storage device, an input/output interface, and a communication interface, and the following operations may be understood as being performed by the processor included in the display system.

In operation 21, the display system may obtain a signal to call the home interface. For example, the display system may receive a control signal for requesting to call the home interface from the remote control device through the sensor or receive a control command for requesting to call the home interface through the transceiver.

In operation 22, the processor may display the home interface on the display. The home interface may include an application (“app”) list and a deep link window. In other words, the processor may display a deep link window(s) including a deep link button(s) respectively corresponding to content data and an application list including an application execution button(s).

In operation 23, the processor may detect a focus input to any one of the execution buttons. The focus input refers to a user input for applying a focus to a virtual button such as an application button or a deep link button. When a selection input is received while the focus is maintained, the processor may execute a function corresponding to the virtual button where the focus is maintained. For example, while the focus on the application execution button is maintained, the processor may execute an application corresponding to the execution button if the selection input is detected. For example, while the focus on the deep link button is maintained, the processor may execute content data corresponding to the deep link button through an associated application if the selection input is detected.

Further, in operation 23, if the focus input is detected for a predefined enable time or more, the processor may set an application corresponding to the execution button where the focus input is detected as an application of interest. If the application of interest is set, the processor may at least partially set the array setting of deep link windows based on at least one of (a) the attribute of the application of interest and (b) the current position of the deep link window (“interested deep link window”) associated with the application of interest.

In operation 23, the attribute of the application of interest means the attribute of the application set as the application of interest. In an embodiment, the attribute of the application may include a content providing attribute and a content non-providing attribute. An application having a content providing attribute may be referred to as a first-type application or a content application, and an application having a content non-providing attribute may be referred to as a second-type application or a content non-providing application. The first application may be configured to be capable of executing content data, and the second application may be configured to be incapable of executing content data.

In operation 23, the deep link windows represented on the home interface may correspond to content applications, respectively. For example, the first deep link window may correspond to the first content application, the second deep link window may correspond to the second content application, and the Kth deep link window may correspond to the Kth content application (where K is a natural number). On the other hand, the content non-providing application may not have a corresponding deep link window. For example, the home interface may at least partially include deep link windows respectively corresponding to the first-type applications among the applications included in the application list, but may not include deep link windows respectively corresponding to the second-type applications. A deep link is for directly executing content data. As such, when the second-type applications which are irrelevant to execution of content data, the absence of deep link window may provide further enhanced user experience and user interface visibility.

In the following disclosure, a process of changing the array setting of the above-described deep link windows in operation 23 is described.

As described above, the home interface may include an application list and a plurality of deep link windows. The deep link windows may be positioned below the application list. Further, the deep link windows may be sequentially arranged over the first to Kth rows.

In an embodiment, when the application of interest is a first-type application and the current position of the interested deep link window is the first row, the processor may not change the array setting. In other words, the array setting may not be changed.

In an embodiment, when the application of interest is a first-type application, and the current position of the interested deep link window is the Mth row (where M is a natural number of 2 or more), the processor may set the array setting so that the deep link windows positioned in the first to Mth rows are positioned in the second to Mth rows, and the interested deep link window positioned in the Mth row is positioned in the first row. In this case, the deep link windows positioned in the M+1th row to the Kth row may be maintained at the existing positions.

In an embodiment, when the application of interest is a second-type application, the processor may not change the array setting regardless of the current position of the interested deep link window.

Although not limited thereto, in an embodiment, when the focus input to the execution button of the application is released, the processor may set the array setting to the default setting. For example, the processor may set the array setting to the default setting based on the focus input on the first application being moved to another user interface element.

Further, in an embodiment, the processor may set the array setting to the default setting based on the change of the focus input to the execution button of the application of interest to another application. For example, based on the focus input to the execution button of the first application set to be of interest being moved to the execution button of the second application, the processor may set the array setting to the default setting. In this case, the processor may maintain the array setting when the focus input to the execution button of the application of interest is moved to a user interface element other than the second application. In other words, the array setting may not be changed to the default setting. Specifically, when the focus input to the execution button of the application of interest is moved to the deep link button, the processor may maintain the array setting.

Meanwhile, in operation 23, the home interface may not include a deep link window corresponding to the application of interest, and in this case, the processor may generate a new deep link window corresponding to the application of interest. The generated new deep link window is positioned in the first row, in substantially the same manner as described above with reference to operation 24, and the remaining deep link windows may be shifted row by row. A case of adding a generated new deep link window is described below with reference to FIG. 8.

As described above, in a state in which the array setting is at least partially changed, the display system may receive a selection input to any one of the deep link buttons.

The display system may obtain content data corresponding to the deep link button where the selection input is received based on receiving the selection input to any one of the deep link buttons. For example, the display system may obtain content data by requesting the content system to transmit content data corresponding to the deep link button. For example, the display system may obtain content data by loading content data corresponding to the deep link button from the storage device.

The display system may execute the obtained content data in an application associated with the deep link button. The deep link button is associated with a content application capable of executing the corresponding content data. The content application may be executed not only based on a selection input to the execution button for executing the content application, but also based on a selection input to the deep link button based on a deep link. When the content application is executed based on the execution button, the function set as default is executed, but when it is executed based on the deep link button, content data associated with the URI corresponding to the deep link button may be executed together with the content application.

FIG. 3 is a reference view illustrating a home interface.

Referring to FIG. 3, a display system (e.g., the display system 13 of FIG. 1A to FIG. 1C) may display a home interface RUI on the display 30. The home interface RUI may include N application button(s) AB₁, AB₂, . . . , AB_{N}, M deep link window(s) DW₁, DW₂, . . . , DW_{M}. Here, M and N are natural numbers, and N is equal to or larger than M.

Each of the application button(s) AB₁, AB₂, . . . , AB_{N} may correspond to or be associated with one application. For example, the first application button may correspond to the first application, and the second application button may correspond to the second application. Accordingly, when a selection input to the first application button is received, the first application may be executed, and when a selection input to the second application button is received, the second application may be executed. Although not limited thereto, the application button(s) AB₁, AB₂, . . . , AB_{N} may be arranged in a row along the horizontal direction in the application list. Further, the application button(s) AB₁, AB₂, . . . , AB_{N} may be represented as representative icons representing their respective applications.

The deep link window(s) DW₁, DW₂, . . . , DW_{M} each may correspond to or be associated with one application. For example, the first deep link window may correspond to the first application, and the second deep link window may correspond to the second application. The first deep link window may represent content data executable through the first application as a deep link button corresponding to each content data, and the second deep link window may represent content data executable through the second application as a deep link button corresponding to each content data.

FIG. 4 is a reference view illustrating a deep link window.

The deep link window DWₓ may include L deep link button(s) DB₁, DB₂, . . . , DB_{L} (where L is a natural number). The specific deep link window DWₓ may include first, second, . . . , Nth deep link windows DWₓ (where N is a natural number).

Each of the deep link button(s) may correspond to content data. For example, the first deep link button may correspond to the first content data, and the second deep link button may correspond to the second content data. If a selection input to the first deep link button is received, content data corresponding to the first deep link button may be executed through an application associated with the deep link window DWₓ including the first deep link button. Further, if a selection input to the second deep link button is received, the content data corresponding to the second deep link button may be executed through an application associated with the deep link window DWₓ including the second deep link button. Meanwhile, although not limited thereto, the deep link button may be represented as a preview image of corresponding content data.

Deep link is a technique for simultaneously executing an application and content data executable through the application and may enhance conversion rate and retention by optimizing user experience. Deep link methods include, but are not limited to, URI schema, universal link, and app link.

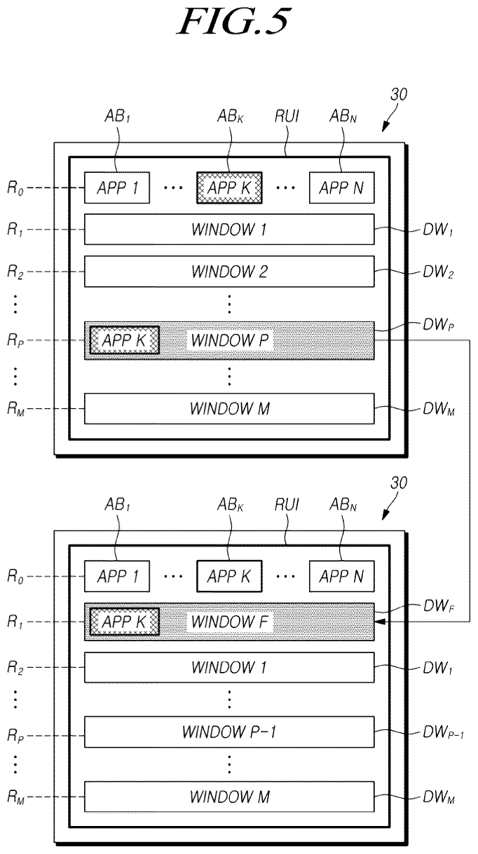

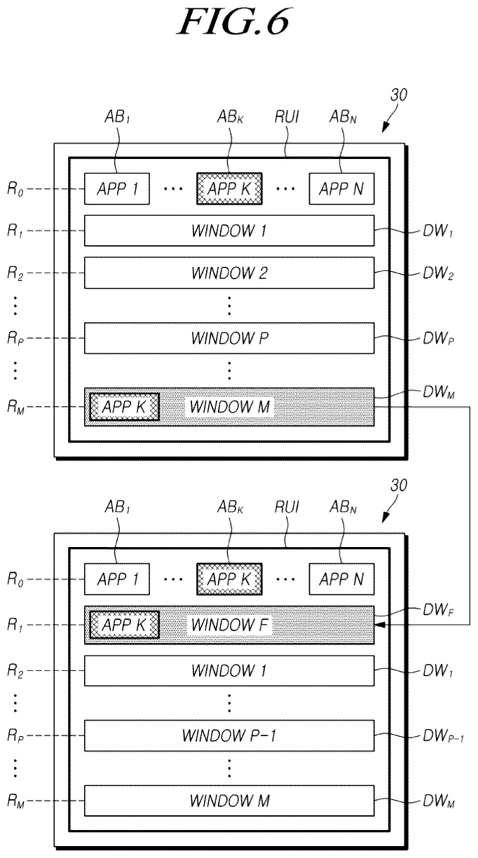

FIGS. 5 and 6 are reference views illustrating a process of moving an interested deep link window. Specifically, FIG. 5 illustrates an example where a deep link window positioned in the middle row among deep link windows is set as an interested deep link window, and FIG. 6 illustrates an example where the deep link window positioned in the last row is set as an interested deep link window.

As described above with reference to FIG. 2, the display system (e.g., the display system 13 of FIG. 1A to FIG. 1C) may set any one of the deep link windows DW₁, DW₂, . . . , DW_{P}, . . . , DW_{M} as the interested deep link window DW_{F}. Specifically, the display system may detect a focus input to any one of the application execution buttons AB₁, . . . , AB_{K}, . . . , AB_{N}. When the focus input is detected for a predefined enable time or more, the display system may (a) set the application (e.g., “APP K”) corresponding to the execution button as an application of interest and (b) set the deep link window DW corresponding to the application of interest (e.g., “APP K”) as the interested deep link window DW_{P}.

Referring to FIG. 5, the display system may position the interested deep link window DW_{F}, which used to be positioned in the Pth row R_{P} (middle row), in the first row R₁. Further, the display system may shift the deep link window(s) (e.g., DW₁ and DW_{P}) which used to be positioned in the first row R₁ to the P−1th row R_{P-1}, to the second row R₂ to the Pth row R_{P}. In other words, as the display system positions the interested deep link window DW_{F} in the uppermost row (e.g., the first row R₁) among the deep link windows, the remaining deep link windows (e.g., DW₁, . . . , DW_{P-1}) may be positioned downward row by row.

Referring to FIG. 6, the display system may position the interested deep link window DW_{F}, which used to be positioned in the Mth row R_{M} (the last row), in the first row R₁. Further, the display system may shift the deep link window(s) (e.g., DW₁ and DW_{M-1}) originally positioned in the first row R₁ to the M−1th row R_{M-1} to the second row R₂ to the Mth row R_{M}. In other words, as the display system positions the interested deep link window DW_{F} in the uppermost row (e.g., the first row R₁) among the deep link windows, the remaining deep link windows (e.g., DW₁, . . . , DW_{M-1}) may be positioned downward row by row.

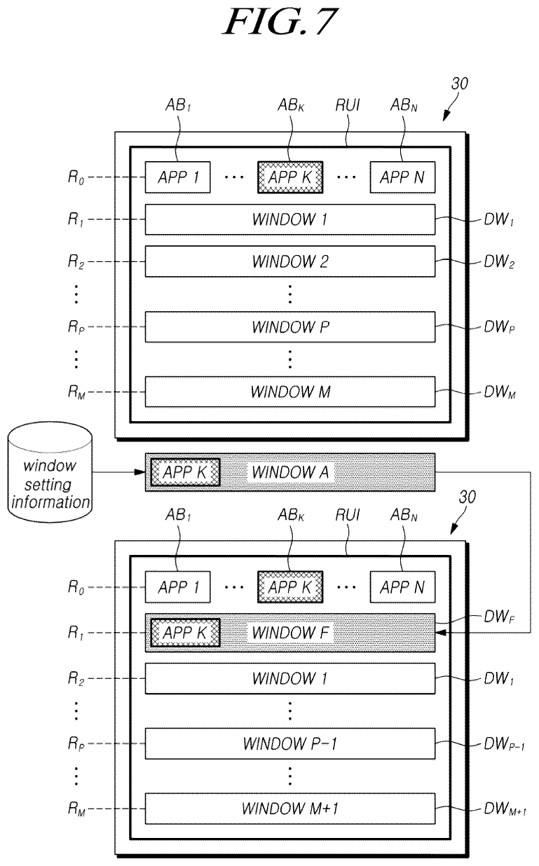

FIG. 7 is a reference view illustrating a process of generating and then moving an interested deep link window.

As described above with reference to FIG. 2, the display system (e.g., the display system 13 of FIG. 1A to FIG. 1C) may set any one of the deep link windows DW₁, DW₂, DW_{P}, . . . , DW_{M} as the interested deep link window DW_{F}. Specifically, the display system may detect a focus input to any one of the application execution buttons AB₁, . . . , AB_{K}, . . . , AB_{N}. When the focus input is detected for a predefined enable time or more, the display system may (a) set the application (e.g., “APP K”) corresponding to the execution button as an application of interest and (b) set the deep link window (e.g., “WINDOW A”) corresponding to the application of interest as the interested deep link window DW_{F}.

However, in some cases, the home interface RUI may not include a deep link window corresponding to the application of interest (e.g. “APP K”). In an embodiment, the display system may generate a new deep link window corresponding to the application of interest or obtain a newly generated deep link window.

For example, the display system may request the deep link system to provide a deep link window (e.g., “WINDOW A”). If the deep link system receives content data from the content system, it may generate a deep link button(s) associated with the provided content data and a deep link window including the same. The deep link system may provide the deep link button(s) and the deep link window including the same to the display system. The display system may newly add the received deep link window (“WINDOW A”) to the home interface RUI.

Further, e.g., the display system may request window setting information for generating the deep link window (“WINDOW A”) from the content system. The window setting information is associated with content data, and may include at least one of, e.g., a content name, a content description, a content creator, a content provider, a content note, a URI, and an arrangement order of a deep link button. The display system may generate a deep link button(s) and a deep link window (“WINDOW A”) including the same based on receiving the window setting information. The display system may newly include or add the generated deep link window (“WINDOW A”) on the home interface RUI.

Referring to FIG. 7, the deep link windows on the home interface RUI set as default may be sequentially arranged along the first row R₁ to the Mth row R_{M}. As described above, the newly generated deep link window (“WINDOW A”) may be set as the interested deep link window DW_{F} because it corresponds to the application of interest.

In an embodiment, the display system may shift the deep link windows DW₁, DW₂, . . . , DW_{P}, . . . , DW_{M} on the home interface RUI set as default to the second row R₂ to the M+1th row R_{M+1}, based on receiving or generating the newly generated interested deep link window DW_{F}.

In an embodiment, the deep link window DW_{M+1} shifted to the M+1th row R_{M+1} may be maintained on the home interface RUI as it is. In other words, since the home interface RUI may include the deep link windows DW_{F}, DW₁, . . . , DW_{P}-1, . . . , DW_{M+1} arranged over the first row R₁ to the M+1th row R_{M+1}, the number of the deep link windows increases to M+1.

In an embodiment, the deep link window DW_{M+1} shifted to the M+1th row R_{M+1} may be omitted or deleted on the home interface RUI. In this case, since the home interface RUI may include the deep link windows DW_{F}, . . . , DW_{M-1} arranged over the first row R₁ to the Mth row R_{M} like previous, the number of the deep link windows is maintained as M.

Meanwhile, also in various embodiments disclosed by referring to FIG. 7, when the focus input to the execution button (e.g., AB_{K}) of the application of interest is released, the display system may set the array setting as the default setting. For example, the display system may set the array setting to the default setting based on the focus input on the first application being moved to another user interface element.

Further, in an embodiment, the display system may set the array setting as the default setting based on the focus input to the execution button (e.g., AB_{K}) of the application of interest being changed to another application (e.g., AB_{K-1} or AB_{K+1}). For example, based on the focus input to the execution button of the first application set to be of interest being moved to the execution button of the second application, the display system may set the array setting to the default setting. In this case, the display system may maintain the array setting, when the focus input to the execution button of the application of interest is moved to a user interface element other than the second application. In other words, the array setting may not be changed to the default setting. Specifically, when the focus input to the execution button of the application of interest is moved to the deep link button, the display system may maintain the array setting.

When changed to the default setting, the interested deep link window DW_{F} newly added to the home interface RUI may be omitted or deleted from the home interface RUI. In an embodiment, the (interested) deep link window DW_{F} omitted or deleted may be recorded in the memory of the display system. The deep link window recorded in the memory may be immediately used by the its own system without the need for requesting the content system or the deep link system when it is needed later.

FIG. 8 illustrates an exemplary computer system.

In embodiments, one or more computer systems 800 perform one or more steps (operations) of one or more methods described or illustrated in the disclosure. In embodiments, one or more computer systems 800 provide functions described or illustrated in the disclosure. In embodiments, software executed on one or more computer systems 800 performs one or more steps of one or more methods described or illustrated in the disclosure or provides functions described or illustrated in the disclosure. An embodiment includes one or more parts of one or more computer systems 800. Here, a reference to a computer system may include a computing device, where appropriate, and vice versa. Further, a reference to a computer system may include one or more computer systems, where appropriate.

The disclosure considers any appropriate number of computer systems 800. The disclosure considers a computer system 800 taking any appropriate physical form. As an example and without limitations, the computer system 800 may be an embedded computer system, system on chip (SOC), single board computer system (SBC) (e.g., a computer on module (COM) or a system on module (SOM)), a desktop computer system, a laptop or notebook computer system, an interactive kiosk, a mainframe, a mesh of computer systems, a mobile phone, a personal digital assistant (PDA), a server, a tablet computer system, an augmented/virtual reality device, or a combination of two or more thereof. Where appropriate, the computer system 800 may include one or more computer systems 800; may be a single one or be distributed; may be present at multiple positions; may be present over multiple machines; may be present in multiple data centers; or may reside in a cloud capable of including one or more cloud components in one or more networks. Where appropriate, one or more computer systems 800 may perform one or more steps of one or more methods described or illustrated in the disclosure without substantial spatial or temporal limitations. As an example and without limitations, one or more computer systems 800 may perform one or more steps of one or more methods described or illustrated in the disclosure in real-time or in a batch mode. One or more computer systems 800 may, where appropriate, perform one or more steps of one or more methods described or illustrated in the disclosure at different times or at different positions.

In embodiments, the computer system 800 includes a processor 802, memory 804, a storage device 806, an input/output (I/O) interface 808, a communication interface 810, and a bus 812. Although the disclosure describes and illustrates a specific computer system having a specific number of specific components in a specific array, the disclosure considers any appropriate computer system having any appropriate number of appropriate components in any appropriate array.

In embodiments, the processor 802 includes hardware for executing instructions, such as instructions constituting a computer program. For example and without limitations, to execute the instructions, the processor 802 may search for (or retrieve) instructions from an internal register, an internal cache, the memory 804, or the storage device 806; decode and execute them; and then write one or more results in the internal register, the internal cache, the memory 804, or the storage device 806. In embodiments, the processor 802 may include one or more internal caches for data, instructions, or addresses. The disclosure considers a processor 802 including any appropriate number of any appropriate internal caches, where appropriate. As an example and without limitations, the processor 802 may include one or more instruction caches, one or more data caches, and one or more translation lookaside buffers (TLBs). The instructions in the instruction caches may be copies of instructions in the memory 804 or storage device 806, and the instruction caches may speed up the search for their instructions by the processor 802. Data in the data caches may be copies of data in the memory 804 or the storage device 806 for instructions executed in the processor 802 to be operated; results of previous instructions executed in the processor 802 to be accessed by subsequent instructions executed in the processor 802 or to write to the memory 804 or storage device 806; or copies of other appropriate data. The data caches may speed up read or write operations by the processor 802. The TLBs may increase the speed of virtual address translation for the processor 802. In embodiments, the processor 802 may include one or more internal registers for data, instructions, or addresses. The disclosure considers a processor 802 including any appropriate number of any appropriate internal registers, where appropriate. The processor 802 may include one or more arithmetic logic units (ALUs); may be a multi-core processor; or may include one or more processors 802, where appropriate. Although the disclosure describes and illustrates a particular processor, the disclosure considers any appropriate processor.

In embodiments, the memory 804 includes a main memory for storing instructions to be executed by the processor 802 or data to be operated by the processor 802. As an example without limitations, the computer system 800 may load instructions from the storage device 806 or another source (e.g., another computer system 800) to the memory 804. The processor 802 may then load instructions from the memory 804 to the internal register or internal cache. To execute the instructions, the processor 802 may retrieve the instructions from the internal register or the internal cache and decode them. During or after execution of instructions, the processor 802 may write one or more results (which may be intermediate or final results) to the internal register or the internal cache. The processor 802 may then write one or more of their results to the memory 804. In embodiments, the processor 802 only executes instructions in one or more internal registers or internal caches or in the memory 804 (as opposed to the storage device 806 or somewhere else) and only operates according to data in one or more internal registers or internal caches or the memory 804 (as opposed to the storage device 806 or somewhere else). One or more memory buses (which each may include an address bus and a data bus) may couple the processor 802 with the memory 804. The bus 812 may include one or more memory buses, as described below. In embodiments, one or more memory management units (MMUs) reside between the processor 802 and the memory 804 and facilitate access to the memory 804 requested by the processor 802. In embodiments, the memory 804 includes random access memory (RAM). The RAM may be a volatile memory when appropriate. Where appropriate, the RAM may be dynamic RAM (DRAM) or static RAM (SRAM). Further, where appropriate, the RAM may be single port or multi-port RAM. The disclosure considers any appropriate RAM. The memory 804 may include one or more memories 804 where appropriate. Although the disclosure describes and illustrates a particular memory, the disclosure considers any appropriate memory.

In an embodiment, the storage device 806 includes a mass storage device for data or instructions. As an example and without limitations, the storage device 806 may include a hard disk drive (HDD), a floppy disk drive, a flash memory, an optical disc, a magneto-optical disc, a magnetic tape, or a universal serial bus (USB), or a combination of two or more thereof. The storage device 806 may include removable or non-removable (or fixed) media, where appropriate. The storage device 806 may be inside or outside the computer system 800, where appropriate. In an embodiment, the storage device 806 is a non-volatile, solid state memory. In embodiments, the storage device 806 includes a read-only memory ROM. Where appropriate, the ROM includes mask programmed ROM, programmable ROM (PROM), erasable PROM (EPROM), electrically erasable PROM (EEPROM), electrically alterable ROM (EAROM), or flash memory or a combination of two or more thereof. The disclosure considers a mass storage device 806 taking any appropriate physical form. The storage device 806 may include one or more storage device control units that facilitate communication between the processor 802 and the storage device 806 where appropriate. Where appropriate, the storage device 806 may include one or more storage devices 806. Although the disclosure describes and illustrates a particular storage device, the disclosure considers any appropriate storage device.

In embodiments, the I/O interface 808 includes hardware, software, or both that provide one or more interfaces for communication between the computer system 800 and one or more I/O devices. The computer system 800 may include one or more of these I/O devices, where appropriate. One or more of the I/O devices may enable communication between a person and the computer system 800. As an example and without limitations, the I/O device may include a keyboard, a keypad, a microphone, a monitor, a mouse, a printer, a scanner, a speaker, a stationary camera, a stylus, a tablet, a touch screen, a trackball, a video camera, another appropriate I/O device, or a combination of two or more thereof. The I/O device may include one or more sensors. The disclosure considers any appropriate I/O devices and any appropriate I/O interfaces 808 therefor. Where appropriate, the I/O interface 808 may include one or more devices or software drivers that enable the processor 802 to drive one or more of the I/O devices. The I/O interface 808 may include one or more I/O interfaces 808 where appropriate. Although the disclosure describes and illustrates a particular I/O interface, the disclosure considers any appropriate I/O interface.

In embodiments, the communication interface 810 includes hardware, software, or both that provides one or more interfaces for communication (e.g., packet-based communication) between the computer system 800 and one or more other computer systems 800 or one or more networks. As an example and without limitations, the communication interface 810 may include a network interface controller (NIC) for communicating with Ethernet or other wire-based networks, or a wireless NIC (WNIC) or wireless adapter for communicating with a wireless network, such as a network adapter or a Wi-Fi network. The disclosure considers any appropriate network and any appropriate communication interface 810 therefor. As an example and without limitations, the computer system 800 may communicate with an Ad hoc network, a near-field personal communication network (PAN), a local area network (LAN), a wide-area network (WAN), a metropolitan area network (MAN), or one or more parts of the Internet, or a combination of two or more thereof. One or more parts of one or more of the networks may be wired or wireless. For example, the computer system 800 may communicate with a wireless PAN (such as a Bluetooth WPAN), a Wi-Fi network, a WI-MAX network, a cellular phone network (such as a global system for mobile communications (GSM) network), or other appropriate wireless networks or a combination of two or more thereof. The computer system 800 may include any appropriate communication interface 810 for any of the networks, where appropriate. The communication interface 810 may include one or more communication interfaces 810, where appropriate. Although the disclosure describes and illustrates a particular communication interface, the disclosure considers any appropriate communication interface.

In embodiments, the bus 812 includes hardware, software, or both that couple the components of the computer system 800 with each other. As an example and without limitations, the bus 812 may include an accelerated graphics port (AGP) or other graphics buses, an enhanced industry standard architecture (EISA) bus, a front-side bus (FSB), a hypertransport (HT) interconnect, an industry standard architecture (ISA) bus, an infiniband interconnect, a low-pin-count (LPC) bus, a memory bus, a micro channel architecture (MCA) bus, a peripheral component interconnect (PCI) bus, a PCI-Express (PCIe) bus, a serial advanced technology attachment (SATA) bus, a video electronics standards association local (VLB) bus, another appropriate bus, or a combination of two or more thereof. The bus 812 may include one or more buses 812 where appropriate. Although the disclosure describes and illustrates a particular bus, the disclosure considers any appropriate bus or interconnection.

In the disclosure, a computer-readable non-transitory storage medium or media may include one or more semiconductor-based or other integrated circuits (ICs) (e.g., field-programmable gate arrays (FPGAs) or application-specific integrated circuits (ASICs), hard disk drives (HDs), hybrid hard drives (HHDs), optical disc drives (ODDs), magneto-optical discs, magneto-optical drives, floppy disks, floppy disk drives (FDDs), magnetic tapes, solid state drives (SSDs), RAM drives, secure digital cards or drives, any other appropriate computer-readable non-transitory storage media, or, where appropriate, an appropriate combination of two or more thereof. The computer-readable non-transitory storage medium may be volatile, non-volatile, or a combination of volatile and non-volatile, where appropriate.

The electronic device according to various embodiments may be one of various types of electronic devices. The electronic devices may include, for example, a display device, a portable communication device (e.g., a smartphone), a computer device, a portable multimedia device, a portable medical device, a camera, a wearable device, or a home appliance. The electronic devices according to an embodiment are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the context clearly indicates otherwise. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, the term “part” or “module” may include a unit implemented in hardware, software, or firmware, and may interchangeably be used with other terms, for example, “logic,” “logic block,” “part,” or “circuitry”. A part or module may be a single integral component, or a minimum unit or part thereof, adapted to perform one or more functions. For example, according to an embodiment, ‘part’ or ‘module’ may be implemented in a form of an application-specific integrated circuit (ASIC).

As used in various embodiments of the disclosure, the term “if” may be interpreted as “when,” “upon,” “in response to determining,” or “in response to detecting,” depending on the context. Similarly, “if A is determined” or “if A is detected” may be interpreted as “upon determining A” or “in response to determining A”, or “upon detecting A” or “in response to detecting A”, depending on the context.

The program executed by the content system 11, the deep link device 12, and/or the display device 13 described herein may be implemented as a hardware component, a software component, and/or a combination thereof. The program may be executed by any system capable of executing computer readable instructions.

The software may include computer programs, codes, instructions, or combinations of one or more thereof and may configure the processing device as it is operated as desired or may instruct the processing device independently or collectively. The software may be implemented as a computer program including instructions stored in computer-readable storage media. The computer-readable storage media may include, e.g., magnetic storage media (e.g., read-only memory (ROM), random-access memory (RAM), floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two UEs (e.g., smartphones), or online. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A method for controlling a display device for a deep link, the method comprising:
displaying deep link windows and an application list in association with application execution buttons and deep link buttons respectively corresponding to content data;
detecting a focus input with respect to any one of the application execution buttons;
based on the focus input being detected for a predefined enable time or more, changing an array setting of the deep link windows, at least partially, based on an attribute of an application of interest corresponding to an execution button in association with which the focus input is detected and a position of a deep link window associated with the application of interest;
based on receiving a selection input with respect to any one of the deep link buttons, obtaining content data corresponding to a deep link button in association with which the selection input is received; and
executing the obtained content data in an application associated with the deep link button.

2. The method of claim 1, wherein the attribute includes a content providing attribute and a content non-providing attribute, and
wherein an application having the content providing attribute or the application of interest is capable of executing the content data, and an application having the content non-providing attribute is incapable of executing the content data.

3. The method of claim 2, wherein the deep link windows respectively correspond to applications having the content providing attribute.

4. The method of claim 2, wherein applications having the content non-providing attribute have no deep link window respectively corresponding thereto.

5. The method of claim 2, wherein the deep link buttons include preview images associated with the content data respectively corresponding thereto.

6. The method of claim 1, wherein the deep link windows form an array of a first row to an Mth row (where M is a natural number of 2 or more), and
wherein, based on the application of interest having a content providing attribute and the position of the deep link window associated with the application of interest corresponding to the first row the array setting is unchanged.

7. The method of claim 1, wherein the deep link windows form an array of a first row to an Mth row (where M is a natural number of 2 or more), and
wherein, based on the application of interest having a content providing attribute and the position of the deep link window associated with the application of interest corresponding to the Mth row, the array setting is changed so that deep link windows of the first row to an M−1th row are positioned in a second row to the Mth row and the deep link window associated with the application of interest is positioned in the first row.

8. The method of claim 1, wherein based on the application of interest having a content non-providing attribute, the array setting is unchanged.

9. The method of claim 1, comprising changing the array setting to a default setting which is a setting before the focus input is detected based on the detection of the focus input being stopped.

10. A method for controlling a display device for a deep link, the method comprising:
displaying an interface including an application list including application execution buttons and deep link windows, the deep link windows including deep link buttons respectively corresponding to content data, and forming an array of a first row to an Mth row (where M is a natural number of 2 or more);
detecting a focus input with respect to any one of the execution buttons;
based on the focus input is detected for a predefined enable time or more, identifying an attribute of an application of interest corresponding to an execution button in association with which the focus input is detected;
generating a deep link window associated with the application of interest based on the attribute of the application of interest;
changing an array setting of the deep link windows by moving deep link windows of the first row to the Mth row to a second row to an M+1th row and positioning the generated deep link window associated with the application of interest in the first row;
based on receiving a selection input with respect to any one of the deep link buttons, obtaining content data corresponding to a deep link button in association with which the selection input is received; and
executing the obtained content data in an application associated with the deep link button.

11. The method of claim 10, wherein based on the deep link window associated with the application of interest being generated, a deep link window moved to the M+1th row is omitted from the interface.

12. The method of claim 10, wherein based on the deep link window associated with the application of interest being generated, a number of deep link windows included in the interface is increased to M+1.

13. The method of claim 10, comprising, omitting the generated deep link window associated with the application of interest from the interface based on the detection of the focus input being stopped, and changing the array setting to a default setting which is a setting before the focus input is detected.

14. A display device for a deep link, comprising:
one or more processors;
memory storing one or more programs that is executable by the one or more processors to perform a process including:
displaying deep link windows and an application list in association with application execution buttons and deep link buttons respectively corresponding to content data;
detecting a focus input with respect to any one of the application execution buttons;
based on the focus input being detected for a predefined enable time or more, changing an array setting of the deep link windows, at least partially, based on an attribute of an application of interest corresponding to an execution button in association with which the focus input is detected and a position of a deep link window associated with the application of interest;
based on receiving a selection input with respect to any one of the deep link buttons, obtaining content data corresponding to a deep link button in association with which the selection input is received; and
executing the obtained content data in an application associated with the deep link button.

15. The display device of claim 14, wherein the attribute includes a content providing attribute and a content non-providing attribute, and
wherein an application having the content providing attribute or application of interest is capable of executing the content data, and an application having the content non-providing attribute is incapable of executing the content data.

16. The display device of claim 15, wherein the deep link windows respectively correspond to applications having the content providing attribute.

17. The display device of claim 15, wherein applications having the content non-providing attribute have no deep link window respectively corresponding thereto.

18. The display device of claim 15, wherein the deep link buttons include preview images associated with the content data respectively corresponding thereto.

19. The display device of claim 14, wherein the deep link windows form an array of a first row to an Mth row (where M is a natural number of 2 or more), and
wherein, based on the application of interest having a content providing attribute and the position of the deep link window associated with the application of interest corresponding to the first row: the array setting is unchanged.

20. The display device of claim 14, wherein the deep link windows form an array of a first row to an Mth row (where M is a natural number of 2 or more), and
wherein, based on the application of interest having a content providing attribute and the position of the deep link window associated with the application of interest corresponding to the Mth row: the array setting is changed so that deep link windows of the first row to an M−1th row are positioned in a second row to the Mth row and the deep link window associated with the application of interest is positioned in the first row.
